(19) United States
(12) Patent Application Publication
(10) Pub. No.: US 2013/0104810 A1
(43) Pub. Date: May 2, 2013

(54) EDIBLE DOG TOYS

(71) Applicant: Canine Genius, San Diego, CA (US)

(72) Inventors: Birte M. HAAKANSSON, Escondido, CA (US); Alise SHATOFF, San Diego, CA (US)

(73) Assignee: CANINE GENIUS, San Diego, CA (US)

(21) Appl. No.: 13/667,523

(22) Filed: Nov. 2, 2012

Related U.S. Application Data
(60) Provisional application No. 61/554,661, filed on Nov. 2, 2011.

(51) Int. Cl. A01K 11/00

(52) U.S. Cl. CPC A01K 15/026
USPC 119/710

(57) ABSTRACT

Disclosed herein is an edible animal toy comprising: a body, wherein the body consists of animal edible material; wherein the body comprises at least one hole opening into a hollow interior, wherein the hollow interior is configured to receive edible treats. Also disclosed herein is an edible animal toy prepared by the process of: mixing two or more edible ingredients to prepare a dough; shaping the dough in a shape of a body having a hollow interior; and baking the shaped dough to obtain the edible animal toy. Also disclosed herein is a method of preparing an edible animal toy, the method comprising: mixing two or more edible ingredients to prepare a dough; shaping the dough in a shape of a body having a hollow interior; and baking the shaped dough to obtain the edible animal toy.

### RELATED APPLICATIONS

The present application claims priority to the U.S. Provisional Application Ser. No. 61/554,661, filed on Nov. 2, 2011, by Haakansson et al., and entitled “EDIBLE DOG TOYS,” the entire disclosure of which, including any drawings, is incorporated by reference herein.

### FIELD OF THE INVENTION

The present invention is in the field of edible animal toys.

### SUMMARY OF THE INVENTION

Disclosed herein is an edible animal toy comprising: a body, wherein the body consists of animal edible material; wherein the body comprises at least one hole opening into a hollow interior, wherein the hollow interior is configured to receive edible treats.

Also disclosed herein is an edible animal toy prepared by the process of: mixing two or more edible ingredients to prepare a dough; shaping the dough in a shape of a body having a hollow interior; and baking the shaped dough to obtain the edible animal toy.

Also disclosed herein is a method of preparing an edible animal toy, the method comprising: mixing two or more edible ingredients to prepare a dough; shaping the dough in a shape of a body having a hollow interior; and baking the shaped dough to obtain the edible animal toy.

### DETAILED DESCRIPTION OF THE EMBODIMENTS

Disclosed herein are edible animal toys having a hollow interior and at least one opening to the hollow interior. The opening is configured to allow treats and edible objects to be placed into the hollow interior. An animal, such as a household pet, for example a cat or a dog, can methodically remove the edible objects from the hollow interior.

Animal toys having a hollow interior with an opening are known in the art. For example, U.S. Pat. Nos. 7,389,748, 7,591,234, and D624,711, all of which are incorporated by reference herein in their entirety, including the drawings, disclose animal toys where an edible treat or food item can be placed inside of the toy, to be removed by the animal. The challenge of removing the edible object from the toy provides long periods of amusement for the animal and prevents rapid boredom and disinterest.

The animal toys disclosed herein are different from those described in the aforementioned U.S. patents. The body of the presently described toys is made of edible materials, whereas the aforementioned U.S. patents describe a toy whose body is made up of inedible polymeric materials, such as plastic or rubber. Having an edible body provides further advantages to the toy. For example:
Animals are attracted to the smell of the edible toy and prefer the edible toy to the inedible one. Consequently, the edible toy makes it possible for an otherwise uninterested animal to get the benefits of the mental stimulation and exercise that the inedible toy provides to the interested animal. Similarly, an animal that normally does not play with rubber/plastic/inedible treat toys is attracted to and plays with the edible treat toy.
Senior dogs who have lost the interest and enthusiasm for inedible treat toys are newly motivated to play with an edible treat toy.
Dogs with health issues, such as loss of sight or hearing, have an easier time playing with the toy since they can more easily target it using their sense of smell.
Certain inedible toys break down into pieces over a period of time. This creates certain negative effects, such as dispersed debris or intestinal blockage when the animal ingests the piece. The edible toys are designed to be safely broken down and eaten by the animal.
Some animals have allergies to plastic or rubber. These animals can get the benefit of the mental stimulation that the toy offers by using the edible toy.
The edible toys do not require any cleaning or maintenance since they are always in the process of being broken done by the dog as it's playing with the toy.
The edible toys can be formulated to meet specific dietary needs.
As discussed herein, the edible toys of the present invention are configured to contain edible treats. Unlike with plastic, rubber or plush toys, when the treats are emptied the edible toy is still engaging and desirable to play with for the dog. It is an ongoing motivator even when the treats are gone.
The edible toys engage a dog's hunting instincts and prey drive from the outset. It is not necessary to train the dog on how to use it unlike with plastic/rubber/plush treat toys that require initial training.

In some embodiments, the body of the edible toys disclosed herein is made up of baked materials. In other embodiments, the body of the edible toys disclosed herein is obtained through an injection molding process. In these embodiments, an edible dough is used instead of the traditional rubber or plastic in the injection molding process. In either case, the dough is cured, either by heating or by any other curing process. In some embodiments, the cooling of the dough after baking or injection molding is curing. Once the dough is cured it hardens. The hardening can be either due to the “cooking” or the drying of the dough. The cured dough, in certain embodiments, is hard so that it provides a challenge to the animal that prefers chewing hard objects such as bones or pieces of wood. However, the cured dough exudes an aroma and provides a taste that is attractive to the animal and maintains its interest in the toy. Baked animal toys, and edible animal toys obtained through injection molding process are known in the art and any number of them can be used with the present toys. Yet, in some embodiments, the edible toys can be formulated to meet specific dietary needs.

The dough for the body of the toy can be shaped in any shape prior to curing. After the toy is cured, the toy will retain that shape. For example, the toy can be made in the shape of a bone, a cylinder, a sphere, or other shapes that are both aesthetically pleasing and are interesting to animals.

In some embodiments, the toy is molded and cured in separate pieces, for example two separate halves or three or four or more separate parts. By this method, the hollow interior and the at least one opening can be created by forming depressions in the dough. After the separate parts are molded and cured, they can be put together and sealed with edible glue or similar materials. In some embodiments, the separate parts are cured partway, i.e., to the point where the part will retain its shape, and then the various pieces are put together to form the toy and sealed with more of the same dough. The complete toy is then cured further to obtain the desired firmness. Thus, in these embodiments, the “glue” is more of the same dough and the toy will present a seamless exterior.

In some embodiments, the edible food or treat is placed inside the depressions before the separate parts of the edible toy are joined before curing. In these embodiments, the treat cures or bakes along with the toy. In some of these embodiments, the toy provides a greater challenge for the animal to extract the treat because the treat can be larger than the opening. In certain of these embodiments, the treat is also baked goods, but is softer than the body of the toy. In some embodiments, the treat completely fills the hollow interior. In these embodiments, the toy is analogous to a cream-filled cannoli, having a softer interior treat enclosed within a harder edible body. In other embodiments, the treat is in several smaller pieces that can move or rattle around inside of the toy, analogous to a chocolate egg having smaller pieces of candy enclosed within it.

In some embodiments, the various parts are made up of different types of dough. These toys provide a more colorful exterior, which is pleasing to the animal owner, while at the same time provide a variety of tastes for the animal that prevents boredom and maintains the animal's interest in the toy.

The hardness of the cured material can be varied depending on the targeted animal. Primarily, the toy must be hard enough to provide a chewing or gnawing challenge to the animal. At the same time, the toy must not be so hard that it does not flake off to provide tasteful enjoyment. Larger animals having stronger teeth and jaw muscles will require toys that are harder than smaller animals. It is well-known in the art to make cured animal treats of varying hardness.

In some embodiments, the opening is large enough to allow the animal owner to insert treats into the toy, but not too large so that the treat would immediately be released from the toy. In some embodiments, the opening has flaps that are made up of softer edible material. The flaps bend inward and allow the treat to enter the hollow body of the edible toy but provide a temporary barrier for the treat's exit.

In some embodiments, the dough comprises one or more of the following ingredients: one or more types of starch, one or more types of oil, one or more types of protein, one or more types of fruit, one or more types of vegetable, one or more types of flavoring, one or more types of supplements, one or more types of stabilizers or preservatives or other miscellaneous ingredients.

In some embodiments, the starch is selected from the group consisting of rice, wheat, potato, corn, brown rice flour, white rice flour, rice powder, barley, oats, sweet rice flour, tapioca starch, oat fiber, and potato starch.

In some embodiments, the oil is selected from the group consisting of flaxseed, chia seed, fish oil, sesame oil, hemp seeds, and mixed tocopherols.

In some embodiments, the protein is selected from the group consisting of chicken meal, chicken, beef, fish, pork, turkey, meat, liver, corn gluten, gluten, soy, soy protein concentrate, peanuts, and peanut meal.

In some embodiments, the fruits and vegetables are selected from the group consisting of pumpkin, sweet potatoes, alfalfa, cranberries, parsley, dehydrated carrots, blueberry, pomegranate, apple, assorted vegetables, tomato, and peas.

In some embodiments, the flavoring is selected from the group consisting of garlic, brewers yeast, peppermint oil, mint, garlic powder, hickory, mesquite, fennel seed powder, parsley oil, green tea extract, vanilla, natural chicken flavor, rosemary, ginger, anise, carob, dill, cinnamon, pumpkin flavor, and peppermint.

In some embodiments, the binder is selected from the group consisting of glycerin, gelatin, lecithin, carageenan gum, water, cellulose powder, dionized water, vegetable gum, and pectin.

In some embodiments, the supplement is selected from the group consisting of calcium carbonate, cholecalciferol, taurine, fructooligosaccharides (FOS), bacillus coagulants, L-carnitine, glucosamine hydrochloride, chondroitin sulfate, capsaicin, dl-alpha tocopheryl acetate, and L-ascrobyl-2polyphosphate.

In some embodiments, the miscellaneous ingredient or stabilizer or preservative is selected from the group consisting of colorings, tricalcium phosphate, citric acid, sodium hexametaphosphate, sodium diacetate, sodium tripolyphosphate, and titanium dioxide.

In one embodiment, the edible toy, as disclosed herein, comprises the following ingredients: rice flour, vegetable glycerin, gelatin, water, cellulose powder, calcium carbonate, sweet potatoes, lecithin, carrageenan gum, natural pumpkin flavor, garlic, brewers yeast, and peppermint oil.

Those of skill in the art recognize what ingredients to choose for a particular line of edible toys. For example, a high protein edible toy is prepared to meet the needs of a particular dog that may be on a high protein diet. Similarly, a toy is prepared with no protein at all but with starch and various flavorings for a dog who may be on a low protein diet. Various vitamins and supplements are introduced into the toys to fit the needs of various dog populations.

As noted above, the edible toys disclosed herein are baked or prepared by injection molding. In some embodiments, the ingredients are selected for the particular line of toy (e.g., a high protein, a low protein, or a high vegetable line of toys). The ingredients are mixed and kneaded into a dough. In some embodiments the kneading is performed manually whereas in other embodiments the kneading is performed by a motorized mixer. The dough is shaped into the desired shape and the shaped dough is placed in an oven for baking.

In the embodiments where the edible toy is prepared by the injection molding process, the ingredients are selected, as discussed above, and blended, mixed, or extruded to form homogenous pellets. Using methods known in the art, the pellets are then processed into a molded article utilizing injection molding, compression molding, transfer molding, pressure forming, or other similar molding methods. The molded article is then removed from the molding machine and cooled.

What is claimed is:

1. An edible animal toy comprising:
a body, wherein the body consists of animal edible material;
wherein the body comprises at least one hole opening into a hollow interior, wherein the hollow interior is configured to receive edible treats.

2. An edible animal toy prepared by the process of:
mixing two or more edible ingredients to prepare a dough;
shaping the dough in a shape of a body having a hollow interior; and
baking the shaped dough to obtain the edible animal toy.

3. The toy of claim 2, wherein the edible ingredients are selected from the group consisting of one or more types of starch, one or more types of oil, one or more types of protein, one or more types of fruit, one or more types of vegetable, one or more types of flavoring, one or more types of supplements, one or more types of stabilizers or preservatives or other miscellaneous ingredients.

4. The toy of claim 3, wherein
i) the starch is selected from the group consisting of rice, wheat, potato, corn, brown rice flour, white rice flour, rice powder, barley, oats, sweet rice flour, tapioca starch, oat fiber, and potato starch; or
ii) the oil is selected from the group consisting of flaxseed, chia seed, fish oil, sesame oil, hemp seeds, and mixed tocopherols; or
iii) the protein is selected from the group consisting of chicken meal, chicken, beef, fish, pork, turkey, meat, liver, corn gluten, gluten, soy, soy protein concentrate, peanuts, and peanut meal; or
iv) the fruits and vegetables are selected from the group consisting of pumpkin, sweet potatoes, alfalfa, cranberries, parsley, dehydrated carrots, blueberry, pomegranate, apple, assorted vegetables, tomato, and peas; or
v) the flavoring is selected from the group consisting of garlic, brewers yeast, peppermint oil, mint, garlic powder, hickory, mesquite, fennel seed powder, parsley oil, green tea extract, vanilla, natural chicken flavor, rosemary, ginger, anise, carob, dill, cinnamon, pumpkin flavor, and peppermint; or
vi) the binder is selected from the group consisting of glycerin, gelatin, lecithin, carageenan gum, water, cellulose powder, dionized water, vegetable gum, and pectin; or
vii) the supplement is selected from the group consisting of calcium carbonate, cholecalciferol, taurine, fructooligosaccharides (FOS), bacillus coagulants, L-carnitine, glucosamine hydrochloride, chondroitin sulfate, capsaicin, dl-alpha tocopheryl acetate, and L-ascrobyl-2polyphosphate; or
viii) the miscellaneous ingredient or stabilizer or preservative is selected from the group consisting of colorings, tricalcium phosphate, citric acid, sodium hexametaphosphate, sodium diacetate, sodium tripolyphosphate, and titanium dioxide.

5. The toy of claim 2, wherein the shaping step of the process further comprises shaping two or more shapes, wherein when the two or more shapes are assembled together they form the body of the edible toy.

6. The toy of claim 2, wherein the baking step of the process comprises baking the shaped body in an oven.

7. The toy of claim 2, wherein the mixing step comprises the step of extruding the dough to form homogeneous pellets.

8. The toy of claim 7, wherein the shaping step comprises processing the pellets into a molded article by injection molding, compression molding, transfer molding, or pressure forming.

9. A method of preparing an edible animal toy, the method comprising:
mixing two or more edible ingredients to prepare a dough;
shaping the dough in a shape of a body having a hollow interior; and
baking the shaped dough to obtain the edible animal toy.

10. The method of claim 9, wherein the edible ingredients are selected from the group consisting of one or more types of starch, one or more types of oil, one or more types of protein, one or more types of fruit, one or more types of vegetable, one or more types of flavoring, one or more types of supplements, one or more types of stabilizers or preservatives or other miscellaneous ingredients.

11. The method of claim 10, wherein
i) the starch is selected from the group consisting of rice, wheat, potato, corn, brown rice flour, white rice flour, rice powder, barley, oats, sweet rice flour, tapioca starch, oat fiber, and potato starch; or
ii) the oil is selected from the group consisting of flaxseed, chia seed, fish oil, sesame oil, hemp seeds, and mixed tocopherols; or
iii) the protein is selected from the group consisting of chicken meal, chicken, beef, fish, pork, turkey, meat, liver, corn gluten, gluten, soy, soy protein concentrate, peanuts, and peanut meal; or
iv) the fruits and vegetables are selected from the group consisting of pumpkin, sweet potatoes, alfalfa, cranberries, parsley, dehydrated carrots, blueberry, pomegranate, apple, assorted vegetables, tomato, and peas; or
v) the flavoring is selected from the group consisting of garlic, brewers yeast, peppermint oil, mint, garlic powder, hickory, mesquite, fennel seed powder, parsley oil, green tea extract, vanilla, natural chicken flavor, rosemary, ginger, anise, carob, dill, cinnamon, pumpkin flavor, and peppermint; or
vi) the binder is selected from the group consisting of glycerin, gelatin, lecithin, carageenan gum, water, cellulose powder, dionized water, vegetable gum, and pectin; or
vii) the supplement is selected from the group consisting of calcium carbonate, cholecalciferol, taurine, fructooligosaccharides (FOS), bacillus coagulants, L-carnitine, glucosamine hydrochloride, chondroitin sulfate, capsaicin, dl-alpha tocopheryl acetate, and L-ascrobyl-2polyphosphate; or
viii) the miscellaneous ingredient or stabilizer or preservative is selected from the group consisting of colorings, tricalcium phosphate, citric acid, sodium hexametaphosphate, sodium diacetate, sodium tripolyphosphate, and titanium dioxide.

12. The method of claim 9, wherein the shaping step further comprises shaping two or more shapes, wherein when the two or more shapes are assembled together they form the body of the edible toy.

13. The method of claim 9, wherein the baking step comprises baking the shaped body in an oven.

14. The method of claim 9, wherein the mixing step comprises the step of extruding the dough to form homogeneous pellets.

15. The method of claim 14, wherein the shaping step comprises processing the pellets into a molded article by injection molding, compression molding, transfer molding, or pressure forming.
